(19) United States
(12) Patent Application Publication
(10) Pub. No.: US 2004/0035377 A1
(43) Pub. Date: Feb. 26, 2004

(54) Two-stroke cycle, free piston, shaft power engine

(76) Inventor: Masachika Arao, Chatsworth, CA (US)

Correspondence Address: MASACHIKA ARAO, 21733 TUBA ST., CHATSWORTH, CA, 91311, US

(21) Appl. No.: 10/230,042

(22) Filed: Aug. 24, 2002

(51) Int. Cl. F02B 33/04

(52) U.S. Cl. 123/73 C

(57) ABSTRACT

A simple two-stroke cycle engine can match the four-stroke cycle engine in efficiency and low exhaust emissions by incorporating a spring powered free-piston reciprocating within a sleeve valve to provide the required separation of gases during the exhaust and intake functions. The exhaust gas is displaced by the free-pistons' top surface, while simultaneously the bottom surface creates suction for the intake process during its upward stroke. These processes are completed in the interval between the effective end of the power stroke and the effective beginning of the compression stroke. The sleeve-valve controlled exhaust and intake ports of the cylinder are at the top and bottom extremities of the free-pistons' travel, respectively. The spring-powered travel of the free-piston to the top of the cylinder starts with the release by “blow-down” of the restraining combustion pressure at the start of opening of the exhaust ports. The continuously moving crankshaft mounted sleeve valve (having a bulkhead closure in-line with the bottom edge of its intake ports) following its upward stroke closing of the intake and exhaust ports, begins compression of both the previously inducted gas charge and the spring against the bottom of the free-piston now stationary against the cylinder head. Through the check valve in the free-piston, the charge is pumped into the combustion chamber with increasing pressure to be ignited by a spark at nearly the top center position of the sleeve valve/bulkhead assembly. Upon combustion, the spring biased free-piston abuts the bulkhead, and in this nested form, the assembly proceeds on its power stroke.

### BACKGROUND

1. Field of Invention

This invention relates to piston type engines of the two-stroke engine cycle operating on the Otto (spark ignited) and Diesel (compression ignition) thermodynamic cycles.

2. Description of Prior Art

The two-stroke cycle gas engine has the advantages of high power density and mechanical simplicity as compared to the four-stroke cycle engine, due to its doubled firing frequency and the absence of mechanically operated valves. However, these advantages are offset by its excessive exhaust emissions and fuel consumption forced upon it due to its lack of the two extra strokes of the four-stroke cycle engine to separate and therefore, cleanly induct the fresh charge and expel the waste gases. Instead, the two-stroke cycle engine must perform these functions in the interval between the ends of the power stroke and the beginning of the compression stroke, through ports in the cylinder wall which are open substantially at the same time during the event of charge filling and exhaust venting. This causes some of the exhaust gas mixing with the fresh charge in the combustion chamber and some of the fresh charge to be lost to the exhaust port. Another disadvantage of the two-cycle engines operation is that the lubricating oil, which is premixed with the fuel, is rejected with the exhaust in the unburned condition to cause additional pollution in the form of odor and smoke.

The undesirable performance has forced the restriction of the two-stroke cycle engine in almost all fields of application and is being replaced by the four-stroke cycle engine, but this substitution has not addressed the remaining important features of the two-stroke engine of its high power density, mechanical simplicity and low cost. Therefore, much effort has been devoted towards correcting the two-stroke engine of its faults. These include the incorporation of an electronically controlled fuel injection, either directly mounted in the cylinder head or used in conjunction with an air blast system. Most efforts have required the addition of an externally mounted air pump adding greatly to the cost and complication of the fuel injection systems but failing to regain the advantages of the type of engine while correcting some of the faults

The high-speed two-stroke cycle Diesel engine has only one significant advantage over the four-stroke cycle type. This is in the higher power density due to the power strokes again occurring twice as often. However it does not share the simplicity and low cost of the two-stroke cycle gas engine in that it also uses the complicated valve system of the four-stroke cycle engine and also requires an externally mounted engine driven air pump of sufficient capacity to provide at approximately one cylinder volume for through flow exhaust scavenging and another for combustion air.

### DESCRIPTION

This engine concept described herein eliminates the major disadvantages of the two-stroke cycle engines operating on either the Otto cycle or the Diesel cycle. The inclusion of a free-piston and sleeve-valve assembly provides for the forced discharge of exhaust gases by positive mechanical displacement and simultaneously creates a mechanically separated, evacuated volume for the aspiration of the fresh charge. This prevents the loss of any of the fresh charge to the exhaust to eliminate the prime cause of excess emissions and low operating efficiency. Also, this method of charge induction eliminates the requirement of the crankcase to provide the pumping action for the charge induction and cylinder scavenging, thus allowing the use of a re-circulating or automotive-type of lubrication system for further reduction in harmful emissions.

The actuation of the sleeve valve is by crankshaft, while the free-piston operating within it derives its free upstroke motion by a compression spring providing engine speeds suitable for industrial applications. For achievement of higher engine speeds, the spring force can be supplemented by utilizing combustion pressure.

### DRAWING FIGURES

FIG. 1. Plan view of Engine.

FIG. 2. Engine operation

FIG. 3. Components of the free-piston 37.

FIG. 4. Components of the sleeve-valve 36.

FIG. 5. Engine with poppet valve 40 in free-piston 37

FIG. 6. High-speed engine configuration

FIG. 7. Engine section of crankcase supplying lubrication and charge mixture

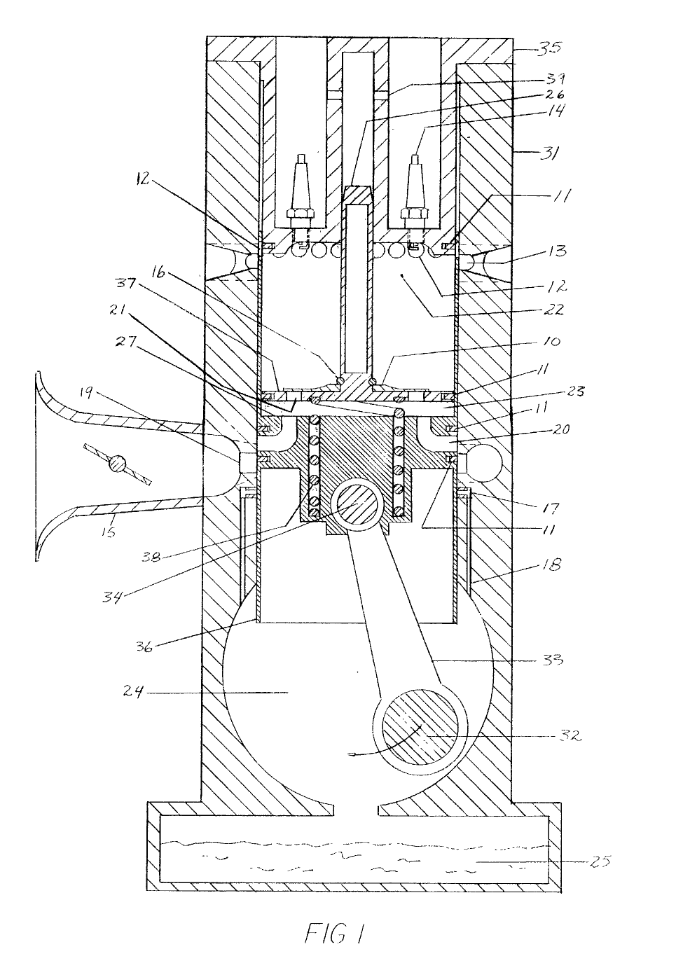

### DESCRIPTIONS OF FIGS. 1-6

### Plan View FIG. 1

The embodiment of an engine in its most basic form incorporating the critical components of this invention is illustrated in schematic form in FIG. 1. These critical components are: free-piston (37), transfer valve (10), spring (38) and sleeve valve (36). An important feature is the ease of incorporating an automotive type of lubrication system.

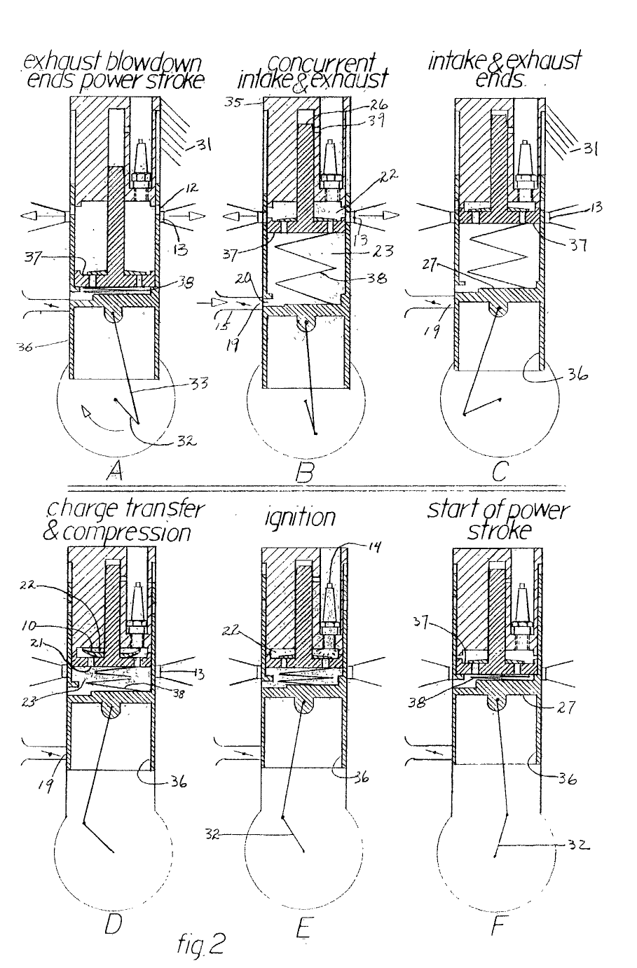

### Operation FIG. 2.

The means of this invention enabling the two-stroke engine to operate with a clean exhaust and fuel efficiency of the four-stroke cycle engine will be evident by the pictorial sequence of operations shown and explained as follows:

Phase A: End of Power Stroke with Exhaust Blow-Down

The sleeve valve 36 and the free-piston 37 are significantly past the effective part of the power stroke when the exhaust ports 12 in the sleeve-valve become partly in registration with the exhaust ports 13 of the cylinder block 31, allowing the escape of sufficient expanded working gas to reduce it from approximately 50 pounds per square inch to approximately atmospheric pressure within 10-15 degrees of crank-shaft 32 rotation. This decrease of the pressure from the top of the free-piston now allows its upstroke acceleration by the previously compressed spring 38.

Phase B: Concurrent Intake and Exhaust

The spring propelled free-piston 37 increases its upward velocity to expel the remaining exhaust gasses and simultaneously creates a vacuum due to a volume increase of the intermediate chamber 23 developing beneath it. Coinciding substantially with the open period of the exhaust ports 13, the intake ports 19 of the cylinder block 31, and the corresponding ports of the sleeve valve 20, are also in the open alignment to allow the admittance of fresh charge. The free-piston is slowed and stopped at the end of its upward stroke by the controlled compression and release of trapped air by the action of the buffer probe 26 with the cylinder head 35 and the pressure relief port 39.

Phase C: End of Intake and Exhaust

The sleeve-valve 36 has moved upwards, closing off the intake 19 and exhaust ports 13 of the cylinder block 31 and is beginning to compress the trapped charge gas now existing between the stationary free-piston 37 and bulkhead 27.

Phase D: Combustion Chamber Charging

As the sleeve-valve 36 continues its upward movement and after closing the intake 19 and exhaust ports 13, (the spring 38 is being compressed in this motion), the charge gas in the intermediate chamber 23 is compressed until the pressure is sufficient to overcome the predetermined opening pressure of the transfer valve 10, allowing the charge gas to transfer from the intermediate chamber to the combustion chamber 22 in a continuing flow thus increasing compression.

Phase E: Charge Ignition

As the sleeve-valve 36 approaches it's top center position, and at 15 to 30 degrees before top dead center position of the crankshaft 32, the highly compressed charge in the combustion chamber 22 is ignited by the spark plug 14.

Phase F: Power Stroke

The increased gas pressure due to combustion forces the free-piston 37 into contact with the bulkhead 27 of the sleeve-valve 36 while further compressing the spring 38, and in this mode forces the crankshaft mounted sleeve-valve to accomplish the power stroke.

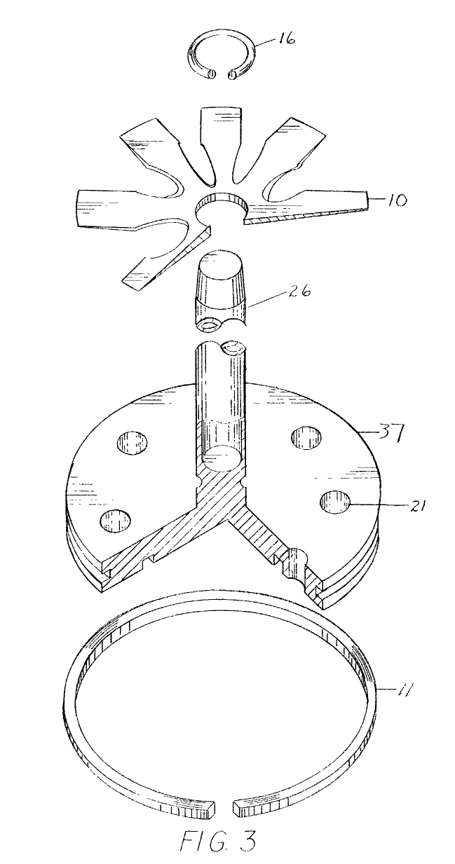

### FIG. 3 The Principle Novelty of Invention

Shown here are the key components of this invention: the free-piston 37 and its integral transfer valve 10, buffer/damper probe 26 and piston ring 11. (The spring 38 is shown in FIG. 1). The free-piston is of lightweight construction. A cushioned stop and damping is provided by the pneumatic compression by the probe 26 as it strokes into the close fitting, mating cavity provided in the cylinder head 35. The transfer valve provides a one-way flow into the combustion chamber. Although the transfer valve is exposed to the high temperatures of combustion, it is also cooled by the flow of charge gases through it such that safe operating temperatures are maintained.

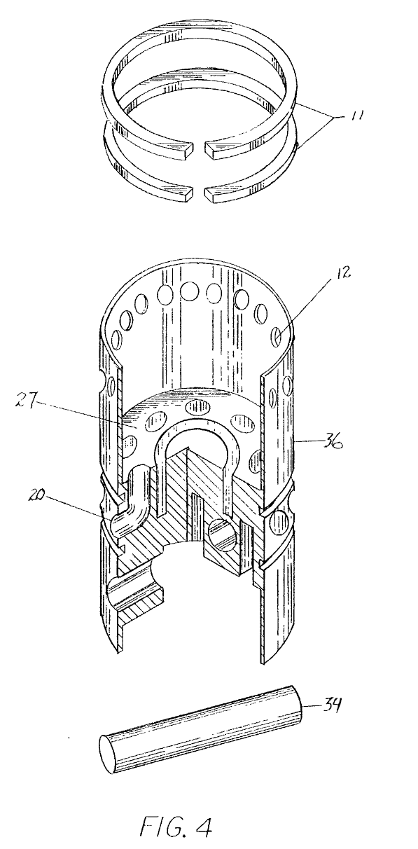

### FIG. 4. Sleeve Valve

The sleeve-valve 36 contains the spring 38 and provides for the containment of the reciprocating free-piston 37. Its thin cylindrical body is perforated with two rows of ports 12 and 20, which are for the exhaust and intake purposes, respectively. These register with matching ports 13 and 19 of the cylinder block 31 at specific portions of its reciprocating travel. Approximately at its mid length, the cylinder is provided with a bulkhead 27, the top surface providing a locating pad for the spring 38 and also serving as the closure in conjunction with the bottom surface of the free piston to form the intermediate chamber 23. This bulkhead also absorbs the force of the free-piston during the power stroke. The wrist pin 34 joins the sleeve-valve through the connecting rod 33 to the crankshaft 32. The straight reciprocating motion of the sleeve-valve can be substituted to one providing a combined reciprocating and oscillating motion for improvements in lubrication, heat transfer, reduction in friction and longer life as demonstrated by the Burt-McCollum single sleeve valve engine ref.—The High-Speed Internal-Combustion Engine, Fifth Edition, H. Ricardo and J. Hempson.

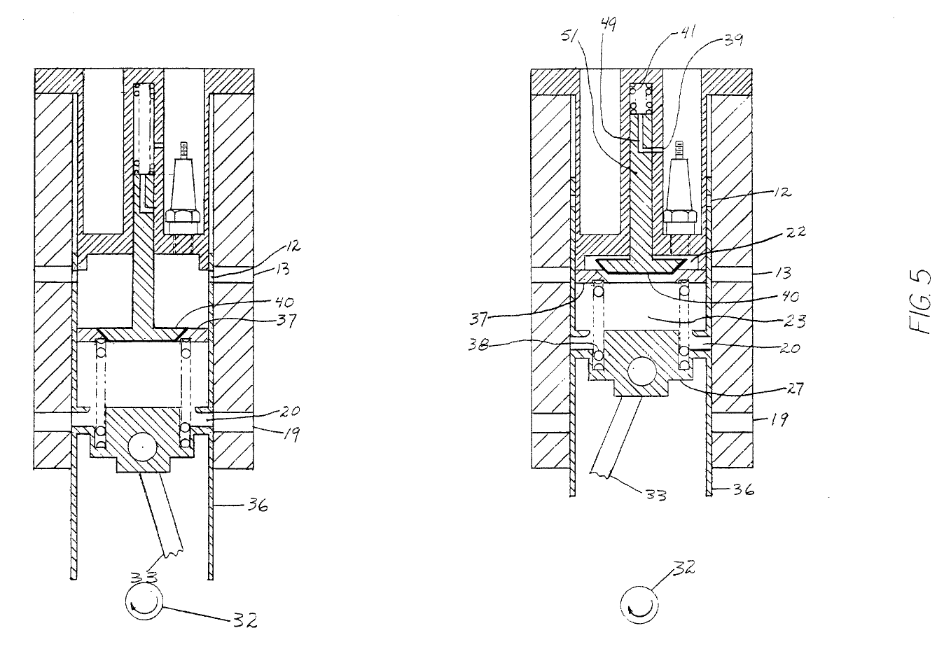

### FIG. 5. Engine with Poppet-Valve in Free-Piston

A variation in the one-way valve controlling the transfer of charge through the free-piston 37 from the intermediate chamber 23 to the combustion chamber 22 is shown here as the poppet-valve 40. The valve is inverted from usual examples of the application of this type of valve to control gas flow through the piston, so that the valve stem 51 can be used to provide the pneumatically controlled slowing and stopping of the upward travel of the rapidly moving free-piston and poppet-valve assembly. Additionally, the poppet-valve in the closed position during the upstroke of the free-piston provides the latter its stabilizing guidance. Pressure relief port 39 and gas port 49 controls the pneumatic pumping action of the valve stem. It also relieves the air pressure remaining in the bore of the valve stem 51 at the end of its upward travel to allow separation of the poppet-valve from the free-piston for the transfer of the charge into the combustion chamber. The spring 38, and also the spring valve seating 41, provides for the reseating of the poppet-valve at the completion of the gas transfer as effected by the sleeve-valve 36 and its integral bulkhead 27 reaching the end of its stroke.

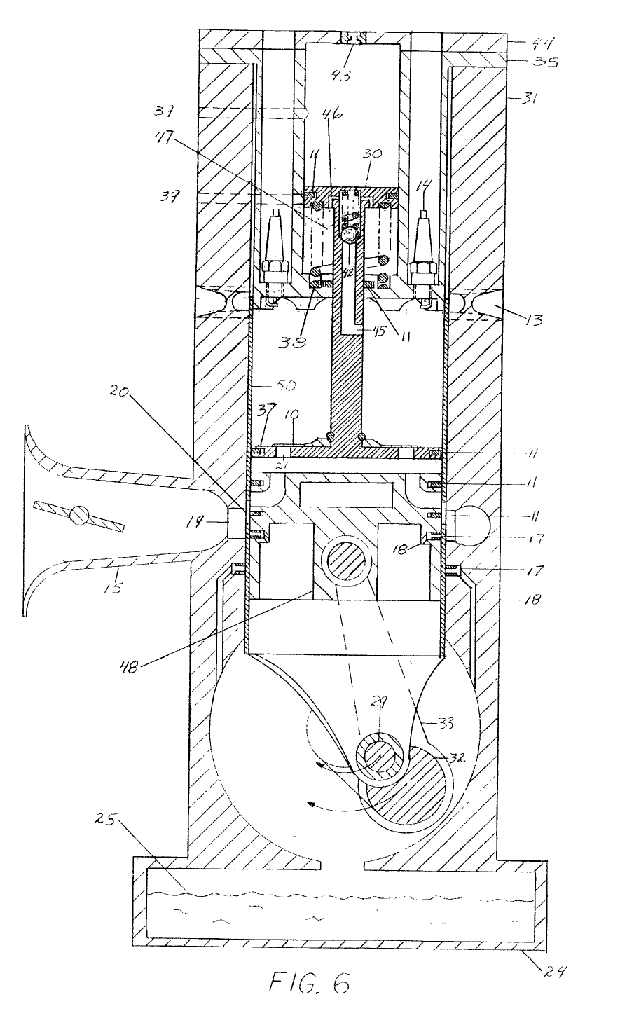

### FIG. 6. High Speed Engine Configuration

To achieve higher engine speeds, alterations in the engine components are configured for applying the combustion gas pressure to augment the spring force returning the free piston and also for reducing the mass of reciprocating parts. The previously shown sleeve valve 36 is lightened by the elimination of the integral bulkhead 27. The new sleeve valve 50 reciprocates over a significantly shorter stroke but sufficient to provide the opening and closing control of the exhaust 13 and intake ports 19. In the configuration shown, the control of the exhaust process is made by the top edge of the sleeve valve 50, rather than through perforated ports as in the control of the intake charge. The reduced stroke of the sleeve valve is provided by a separate, shorter crankthrow 29 combined into the crankshaft 32. The separated bulkhead, now relabeled piston 48, reciprocates at the same stroke made by the previously described sleeve valve 36, its function remaining the same, but accomplished with reduced inertia. The braking and damping mechanism for the free piston 37 and means for its combustion gas pressure aided return, includes the slave piston 30, slave cylinder 47, check valve 42, combustion pressure inlet port 45, combustion pressure discharge port 46, pressure relief ports 39 and damping orifice 43. The high-pressure combustion chamber gas existing immediately prior to the opening of the exhaust ports is tapped and directed to the bottom side of the slave piston 36 to augment the upward force of the spring 38 to increase the return speed of the free-piston. The check valve retains the highest combustion pressure tapped.

This gas powers the slave piston upwards as soon as the “blow-down” portion of the exhaust phase is completed. Relief ports are positioned to eliminate compression of air in the upper side of the slave piston to prevent its reduction of return velocity through the mid-stroke. The rapid upward travel of the free-piston and the slave-piston is arrested to a cushioned stop by the restricted release of compressed air through the damping orifice.

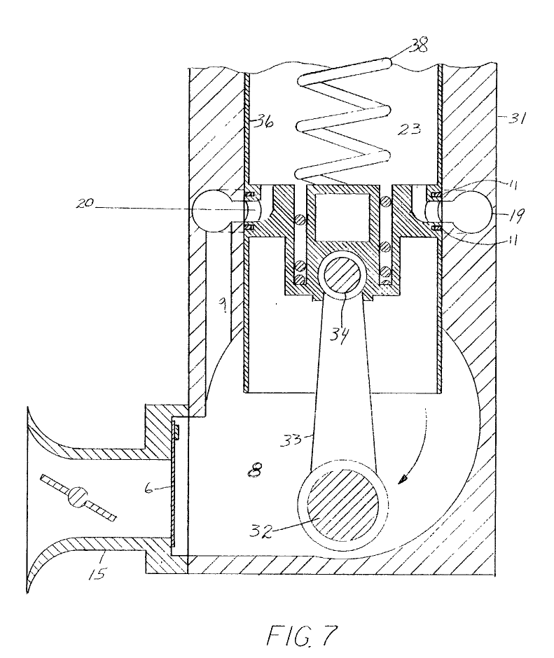

### FIG. 7. Crankcase Supplied Charge and Lubrication Mixture

The normally used system in the common two stroke cycle engines of a crankcase powered charge induction and combined oil mist lubrication system is shown. The application here with the free-piston concept is a performance of greatly reduced emissions as none of the charge is lost to the exhaust, and since all of the lubricant is combusted in the engine as additional fuel after it has served its primary function of lubrication, increased fuel economy results. In addition to simplifying and reducing the cost of the engine, this system allows the engine to operate in any position. The power increasing supercharge crankcase compression pressure of 6-7 pounds per square inch acting on the bottom of the free piston during the induction period, will add significantly to the force of the spring 38 powering the return stroke of the free-piston. This additional force increases the speed capability of the engine.

The charge induction after the carburetor 15 is controlled with a one-way valve 6, however, any of the methods used in existing two-stroke cycle engines including piston controlled ports (in this case sleeve-valve controlled) or various forms of rotary valves can be used.

### Reference Numerals in Drawings

Reference Numerals in Drawings

| Part Name | Part Number |
|---|---|
| Induction Check Valve | 6 |
| Charge and Lubricant Crank Case | 8 |
| Transfer Passage to Sleeve Valve | 9 |
| Transfer Valve | 10 |
| Piston Ring | 11 |
| Exhaust Ports, Sleeve Valve | 12 |
| Exhaust Ports, Cylinder Block | 13 |
| Spark Plug (Fuel Injector, Diesel) | 14 |
| Carburetor (Fuel Injector, Gas) | 15 |
| Retaining Ring | 16 |
| Oil Scraper Ring | 17 |
| Oil Drain Port | 18 |
| Intake Ports, Cylinder Block | 19 |
| Intake Ports, Sleeve Valve | 20 |
| Transfer Ports, Combustion Chamber | 21 |
| Combustion Chamber | 22 |
| Intermediate Chamber | 23 |
| Crank Case | 24 |
| Lubricating Oil | 25 |
| Buffer Probe | 26 |
| Bulkhead | 27 |
| Crank-Sleeve Valve Drive | 29 |
| Slave Piston | 30 |
| Cylinder Block | 31 |
| Crankshaft | 32 |
| Connecting Rod | 33 |
| Wrist Pin | 34 |
| Cylinder Head | 35 |
| Sleeve-Valve | 36 |
| Free-Piston | 37 |
| Spring | 38 |
| Pressure Relief Port | 39 |
| Poppet Valve Assembly | 40 |
| Spring, Valve Seating | 41 |
| Check Valve | 42 |
| Damping Orifice | 43 |
| Cap, Slave Cylinder | 44 |
| Combustion Pressure Inlet Port | 45 |
| Combustion Pressure Discharge Port | 46 |
| Slave Cylinder | 47 |
| Piston | 48 |
| Gas Port | 49 |
| Sleeve-Valve, Lightened | 50 |
| Valve Stem | 51 |

### Objects and Advantages

Accordingly, besides the several objects and advantages described herein, additional objects and advantages are:

a. Retains most of the traditional simplicity, low cost and high power density of the two-stroke cycle engine.

b. All improvements accomplished by incorporation of parts easily manufactured and maintainable with standard level of skills by eliminating electronic computers, fuel injectors, external air compressor and electronically controlled valves, for the smaller engines where most two-stroke cycle engines are used.

c. Duplicates the fuel efficiency and low exhaust emissions of the four-stroke cycle engine.

Other Advantages are:

a. The 360-degree distribution of each port system results in large port areas for maximum efficiency in exhaust venting and charge induction.

b. Complete circumferential porting of the sleeve valve 36 allowing the use of smaller holes to prevent the snagging of the piston rings for greater life and reliability.

c. All forms of supercharging and charge inter-cooling can be used to enable development of increased power. Higher boost pressures and/or compression ratios can be used before the onset of detonation in the Otto cycle or gas engine because of the reduced operating temperature of the piston. Supercharging also augments the return force of the spring powering the free piston, resulting in increased engine speed capability.

d. Lower cost but more efficient and compact two-stroke cycle Diesel engine by eliminating the need of the complex valve system of the four-stroke cycle engine type and the engine driven scavenging air pump.

e. Especially suited for the double-acting cylinder configuration in Otto or Diesel cycles for the ultimate concentration of power and smoothness of power flow.

I claim:

1. An article of engine, specifically a two-stroke cycle type wherein the improvement comprises a free-piston 37, located within the engine, which after its power stroke, makes a return stroke substantially independent of the crankshaft 32 to accomplish the separated but substantially simultaneous induction of fresh charge and expulsion of the waste gas.

2. The engine of claim 1 wherein in said free-piston having means including a spring for forcing its return to the top center or firing position.

3. The free-piston of claim 2 contains means of valving, consisting of a single or plurality of valves having a predetermined opening pressure for providing a one way flow of said fresh charge from the intermediate chamber 23 to the combustion chamber 22.

4. The free-piston of claim 2 contain sealing means including piston ring(s) 11 to maintain separation of gases between the said free-pistons top and bottom surfaces.

5. The free-piston of claim 2 contain means to achieve both guidance in the cylinder bore and a controlled stop terminating its return to the firing position including an integral buffer probe 26 in the form of a substantially concentric and reduced diameter to the said free-piston for the close, sliding fit and pneumatic pumping ability in the cylinder head 35.

6. The engine of claim 1 containing means of valving for the timed control of induction of the fresh charge and the expulsion of the waste gas including a said crankshaft driven sleeve valve 36 having suitable perforations of its wall thus forming the exhaust ports 12 and intake ports 20 to slideably register with the corresponding static port perforations of the cylinder block 31.

7. The engine of claim 1 containing means to contain slideably said free-piston and also provide means during its said power stroke to transfer its energy to the said crankshaft including through said sleeve valve having an integral bulkhead 27 which provides for abutment of the free-piston on its adjacent side and provision for connecting to the crankshaft on the opposite side, the said bulkhead also enabling the formation of a control volume for induction of the fresh charge and its subsequent compression for enabling its transfer through the free-piston.

8. The engine of claim 1 for its starting contain means for creating a vacuum for the induction of said fresh charge including the retention of said free piston in its substantially top center position by said spring in claim 2 while the said sleeve-valve with said integral bulkhead is moved toward the bottom center position.

9. The engine of claim 1 with said cylinder block having either a single or plurality of bores to accept coaxially and slideably said sleeve valve(s), the said bore(s) provided with plurality of holes pierced radial substantially in line with the combustion chamber thus forming the exhaust ports 13 and a second row with plurality of holes pierced radial substantially in line with the top surface of the bulkhead when said sleeve valve is at said bottom center position, thus forming the intake ports 19.

10. The engine of claim 1 embodying a cylinder head 35 providing means for the end closure of the said combustion chamber, the mounting of spark plug(s) 14 or fuel injector(s), inclusion of a mating cavity for the said buffer probe, and the fitment of said piston ring type seals for the prevention of gas leakage between said cylinder head and the inner diameter of said sleeve valve and in conjunction with the said cylinder block, form a closed annular space for the sliding containment of the sleeve valve.

11. The engine of claim 1 embodying a crankcase 24 providing the means for an automotive type of lubrication system, but without an auxiliary pump to provide exhaust gas scavenging and charge induction.

12. The engine of claim 1 embodying a crankcase 24 FIG. 7 providing inhalation of a charge consisting of fuel, oil and air and the compression of the same to urge its transfer to the cylinder portion of the engine.
